(19) United States
(12) Patent Application Publication
(10) Pub. No.: US 2018/0207875 A1
(43) Pub. Date: Jul. 26, 2018

(54) METHOD AND SYSTEM FOR 3D PRINTING

(71) Applicant: Stratasys Ltd., Rehovot (IL)

(72) Inventor: Guy MENCHIK, RaAnana (IL)

(21) Appl. No.: 15/744,880

(22) PCT Filed: Jul. 13, 2016
(86) PCT No.: PCT/IL2016/050752

§ 371 Date: Jan. 15, 2018

Related U.S. Application Data
(60) Provisional application No. 62/191,600, filed on Jul. 13, 2015.

(51) Int. Cl. B29C 64/393; B29C 64/112; B33Y 10/00; B33Y 30/00; B33Y 50/02; G06T 7/00; G06F 3/12

(52) U.S. Cl. CPC B29C 64/393; B29C 64/112; B33Y 10/00; B33Y 30/00; G06T 2207/30144; G06T 7/0008; G06F 3/1296; G06F 3/121; G06F 3/1259; B33Y 50/02

(57) ABSTRACT

An additive manufacturing (AM) system includes a dispensing unit that dispenses building material in a layer-wise manner to manufacture an object, a building tray receiving the building material dispensed, a camera capturing images of the building material dispensed, a processor processing output from the camera and a controller controlling operation of the dispensing unit and the camera.

### RELATED APPLICATIONS

This application claims the benefit of priority of U.S. Provisional Patent Application No. 62/191,600 filed on Jul. 13, 2015, the contents of which are incorporated herein by reference in their entirety. The contents of International Patent Application, publication No. WO2016/009426 is also incorporated by reference as if fully set forth herein.

### FIELD AND BACKGROUND OF THE INVENTION

The present invention, in some embodiments thereof, relates to freeform manufacturing and, more particularly, but not exclusively, to a three dimensional (3D) printing.

Additive manufacturing (AM) is generally a process in which a 3D object is manufactured utilizing a computer model of the object. Such a process is used in various fields, such as design related fields for purposes of visualization, demonstration and mechanical prototyping, as well as for rapid manufacturing.

The basic operation of any AM system consists of slicing a 3D computer model into thin cross sections, translating the result into two-dimensional position data and feeding the data to a controller of a system that constructs a 3D structure in a layer-wise manner.

AM entails many different approaches to the method of fabrication, including 3D printing, e.g., 3D inkjet printing, laminated object manufacturing, fused deposition modeling and others.

In 3D printing processes, for example, a building material is dispensed from a dispensing head having a set of nozzles to deposit layers on a supporting structure. Depending on the building material, the layers may then be cured or solidified using a suitable device. The building material may include modeling material, which forms the object, and support material, which supports the object as it is being built. Various 3D printing techniques exist and are disclosed in, e.g., U.S. Pat. Nos. 6,259,962, 6,569,373, 6,658,314, 6,850,334, 7,183,335 7,209,797, 7,225,045, 7,300,619, 7,364,686, 7,500,846, 7,658,976, 7,962,237 and 9,031,680, and U.S. Published Application No. 20130040091, all of the same Assignee, the contents of which are hereby incorporated by reference.

For example, U.S. Pat. No. 9,031,680 discloses a system which comprises an AM apparatus having a plurality of dispensing heads, a building material supply apparatus configured to supply a plurality of building materials to the fabrication apparatus, and a control unit configured for controlling the fabrication and supply apparatus. The system has several operation modes. In one mode, all dispensing heads operate during a single building scan cycle of the fabrication apparatus. In another mode, one or more of the dispensing heads is not operative during a single building scan cycle or part thereof.

### SUMMARY OF THE INVENTION

According to an aspect of some embodiments of the present invention there is provided a 3D printer with a camera that is operated to monitor the printing process. According to some embodiments of the present invention the camera captures images of the layers during construction and output from the camera is compared to computer object data defining the layers.

According to an aspect of some embodiments of the present invention there is provided a 3D printer that is configured to continue printing while print cartridges supplying building material for printing are being replaced. According to some embodiments of the present invention, the system includes a user interface that alerts the user when the cartridges are close to emptying so that the user can replace the cartridges before the supply of building material that can be used for printing is exhausted.

According to an aspect of some embodiments of the present invention there is provided a 3D printer with a removable substrate placed on a print platen of the 3D printer during printing. According to some embodiments of the present invention, an object is constructed over the substrate and the object together with the substrate is removed from the printing chamber at the termination of the printing process.

According to an aspect of some embodiments of the present invention there is provided an AM system comprising: a dispensing unit configured to dispense building material in a layer-wise manner to manufacture an object; a building tray positioned to receive the building material dispensed; a camera configured for capturing images of the building material dispensed on the building tray during manufacturing; a processor configured for processing output from the camera; and a controller configured to control operation of the dispensing unit and the camera.

Optionally, the processor is configured to relate the output from the camera to computer object data defining manufacturing of the object.

Optionally, the control is configured to adapt operation of the dispensing unit based on the output processed by the processor.

Optionally, the processor is configured to identify missing material in a layer based on the output processed by the processor.

Optionally, the controller is configured to initiate an additional pass of the dispensing unit based on the processor identifying missing material in a layer.

Optionally, the camera is a line camera.

Optionally, the camera is an area camera.

Optionally, the camera is associated with an illumination unit configured to illuminate a portion the building material dispensed on the building tray captured by the camera.

Optionally, the system includes a three dimensional (3D) printer.

Optionally, the 3D printer is an inkjet printer.

Optionally, the dispensing unit and the camera are mounted on a platform.

Optionally, the platform is configured to advance in a scanning direction while the dispensing unit dispenses material of a layer.

Optionally, the building tray is configured to rotate about a vertical axis while the dispensing unit dispenses material of a layer and the camera captures images.

Optionally, the dispensing unit together with the camera is configured to advance in a radial direction with respect to the vertical axis to print different passes of a layer.

Optionally, the camera is configured to capture images of a single layer or a portion of a single layer.

Optionally, the controller is configured to initiate an alert to an operator based on the output processed by the processor.

Optionally, the camera is configured for capturing images in color.

According to an aspect of some embodiments of the present invention there is provided a method for AM comprising: dispensing building material in a layer-wise manner based on computer object data to manufacture an object with an AM system; capturing images of the building material dispensed during manufacturing of the object;

identifying errors in dispensing based on the images captured during manufacturing of the object; and correcting or reporting the error during manufacturing of the object.

Optionally, the correcting includes selectively dispensing additional building material based on the error identified.

Optionally, the correcting includes altering a pattern for dispensing building material in a subsequent layer based on the error identified.

Optionally, the image is a line image captured from a line image sensor.

Optionally, the image is an area image captured with a two-dimensional image sensor.

Optionally, the image is a color image.

Optionally, the method includes leveling a layer and capturing an image after the leveling.

Optionally, the method includes aligning location of the dispensing based on the images captured.

According to an aspect of some embodiments of the present invention there is provided a method for AM comprising: detecting that a cartridge is emptying; initiating an alert configured to alert an operator to replace the cartridge; and reducing a rate of printing over a period that an operator is replacing the cartridge.

Optionally, the method includes detecting replacement of the cartridge; and restoring the rate of printing based on the detecting replacement.

Optionally, the detecting that a cartridge is emptying is with a drop counter.

Optionally, the rate of printing is reduced by 30 to 80 percent.

Optionally, the method includes detecting that two cartridges are emptying; and restoring the rate of printing based on detecting replacement of the two cartridges.

According to an aspect of some embodiments of the present invention there is provided an AM system comprising: a dispensing unit configured to dispense building material in a layer-wise manner to manufacture an object; a supply system including one or more cartridges, the cartridges configured to supply building material to the dispensing unit; a sensor configured to detect that a cartridge is emptying; and a controller configured to: initiate an alert to alert an operator to replace the cartridge; and reduce a rate of printing over a period that an operator is replacing the cartridge.

Optionally, the sensor is configured to detect that the cartridge has been replaced.

Optionally, the controller is configured to restore the rate of printing when the cartridge is replaced.

Optionally, the sensor is a load cell or a drop counter.

According to an aspect of some embodiments of the present invention there is provided an AM system comprising: a dispensing unit configured to dispense building material in a layer-wise manner to manufacture an object; a building tray positioned to receive the building material dispensed; and a removable lining secured on the building tray during manufacturing.

Optionally, the building tray is magnetized during manufacturing and the lining is metal.

Optionally, the lining is secured on the building tray with a vacuum.

Optionally, the lining is reusable.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an AM system in accordance with some embodiments of the invention;

FIGS. 2A-2C are schematic illustrations of printing heads in accordance with some embodiments of the present invention;

FIGS. 3A-3B are schematic illustrations demonstrating coordinate transformations in accordance with some embodiments of the present invention;

FIG. 4 is a simplified flow chart of an exemplary method for monitoring manufacturing of an object with an AM system in accordance with some embodiments of the present invention;

FIG. 5 is a simplified flow chart of an exemplary method for replacing printing cartridges while printing in accordance with some embodiments of the present invention; and

FIG. 6 is an exemplary 3D printing system including a tray with removable lining in accordance with some embodiments of the present invention.

### DESCRIPTION OF SPECIFIC EMBODIMENTS OF THE INVENTION

The present invention, in some embodiments thereof, relates to freeform manufacturing and, more particularly, but not exclusively, to a three dimensional (3D) printing.

According to some embodiments of the present invention, an AM system includes a monitoring system comprising a camera for monitoring manufacturing of the object by comparing the pattern of dispensed material of a layer or a part of a layer to computer object data defining the layer. The camera can be an area camera or a line camera. Optionally, the camera is mounted together with a dispensing unit on a printing platform that advances in a scanning direction while the dispensing unit dispenses the material of the layer. In some exemplary embodiments, a user interface alerts an operator if a discrepancy is detected. According to some embodiments of the present invention, output from the camera is used to detect missing material in a layer. Optionally, in response to detecting missing material the AM system initiates, e.g. without operator intervention, an additional pass (or passes) to fill in the missing material.

One of the known challenges in AM manufacturing is reducing the time for manufacture. If a system has to be paused during manufacturing to supply building material, valuable time is wasted. In addition, if the manufacturing is allowed to continue until the building material is exhausted, deposition in the area where the material is near exhausted maybe inaccurate and a seam may develop in the area at which the manufacturing was paused. According to some embodiments of the present invention, AM system is configured to continue operating while an operator replaces cartridges including building material for constructing the object. Typically, the system includes a sensor that senses when a cartridge is near empty and a user interface alerts the operator. According to some embodiments of the present invention, the system is configured to slow down the printing rate when the sensor senses that the cartridge is near empty so that replacement of the cartridge can be completed before the building material supply is exhausted. Typically, building material accumulated in channels leading from the cartridge to the dispensing nozzle provides for continuing manufacturing for a defined period after the cartridge is empty. By slowing down the rate of printing, the defined period of time can be extended to provide adequate time for cartridge replacement without exhausting the supply of building material.

Another challenge in 3D printing is associated with separating the object from the building tray at the end of the manufacturing process. This is especially true for printers that only provide obstructed access to a printing chamber of the printer. In addition, since the access to the chamber is at times obstructed, cleaning the tray between manufacturing sessions may be difficult and time consuming. According to some embodiments of the present invention, the building tray is lined with a substrate that is secured to the building tray during manufacturing but can be easily removed with the manufactured object from the chamber at the end of the manufacturing process. In some exemplary embodiments, the lining is made from plastic or metal. Typically, the lining is hydrophobic. In some exemplary embodiments, lining includes a coating to provide for easily separating an object constructed with a polymer material from the substrate. The lining can be reusable or disposable.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

The method and system of the present embodiments manufacture 3D objects based on computer object data in a layer-wise manner by forming a plurality of layers in a configured pattern corresponding to the shape of the objects. The computer object data can be in any known format, including, without limitation, a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD).

The term “object” as used herein refers to a whole object or a part thereof.

Each layer is formed by an AM apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material, and which type of building material is to be delivered thereto. The decision is made according to a computer image of the surface.

In preferred embodiments of the present invention, the AM comprises 3D printing, more preferably 3D inkjet printing. In these embodiments a building material is dispensed from a dispensing head having a set of nozzles to deposit building material in layers on a supporting structure. The AM apparatus thus dispenses building material in target locations which are to be occupied and leaves other target locations void. The apparatus typically includes a plurality of dispensing heads, each of which can be configured to dispense a different building material. Thus, different target locations can be occupied by different building materials. The types of building materials can be categorized into two major categories: modeling material and support material. The support material serves as a supporting matrix or construction for supporting the object or object parts during the fabrication process and/or other purposes, e.g., providing hollow or porous objects. Support constructions may additionally include modeling material elements, e.g. for further support strength.

The modeling material is generally a composition which is formulated for use in AM and which is able to form a 3D object on its own, i.e., without having to be mixed or combined with any other substance.

The final 3D object is made of the modeling material or a combination of modeling materials or modeling and support materials or modification thereof (e.g., following curing). All these operations are well-known to those skilled in the art of solid freeform fabrication.

In some exemplary embodiments of the invention an object is manufactured by dispensing two or more different modeling materials, each material from a different dispensing head of the AM system. The materials are optionally and preferably deposited in layers during the same pass of the printing heads. The materials and combination of materials within the layer are selected according to the desired properties of the object.

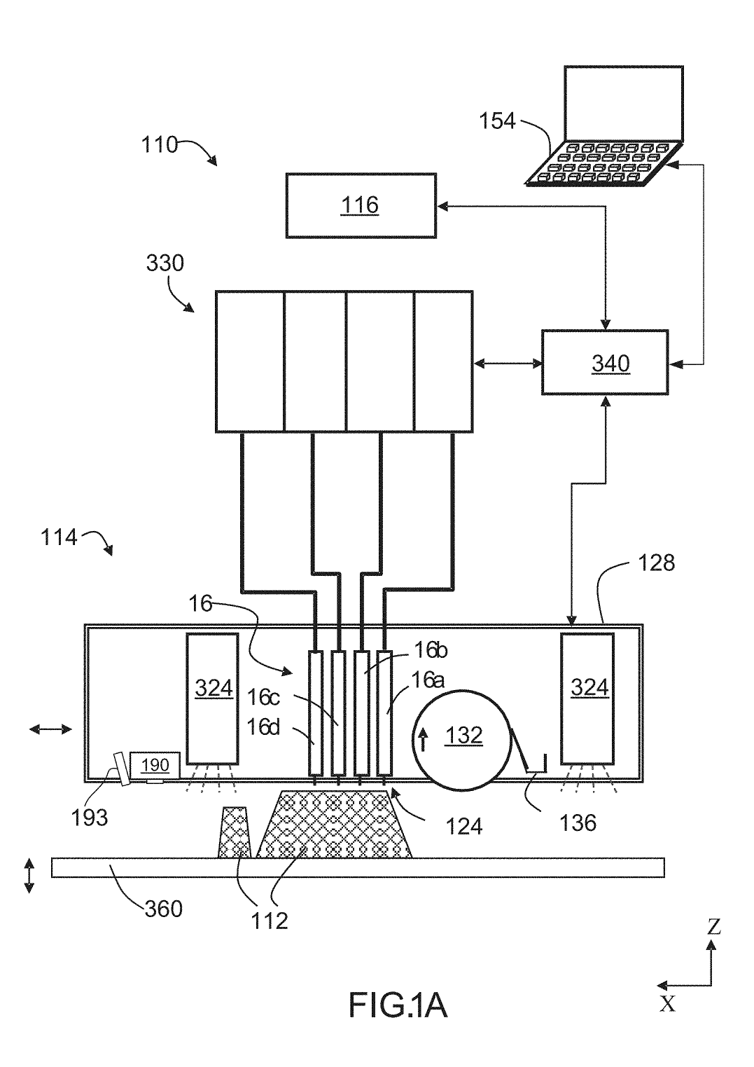

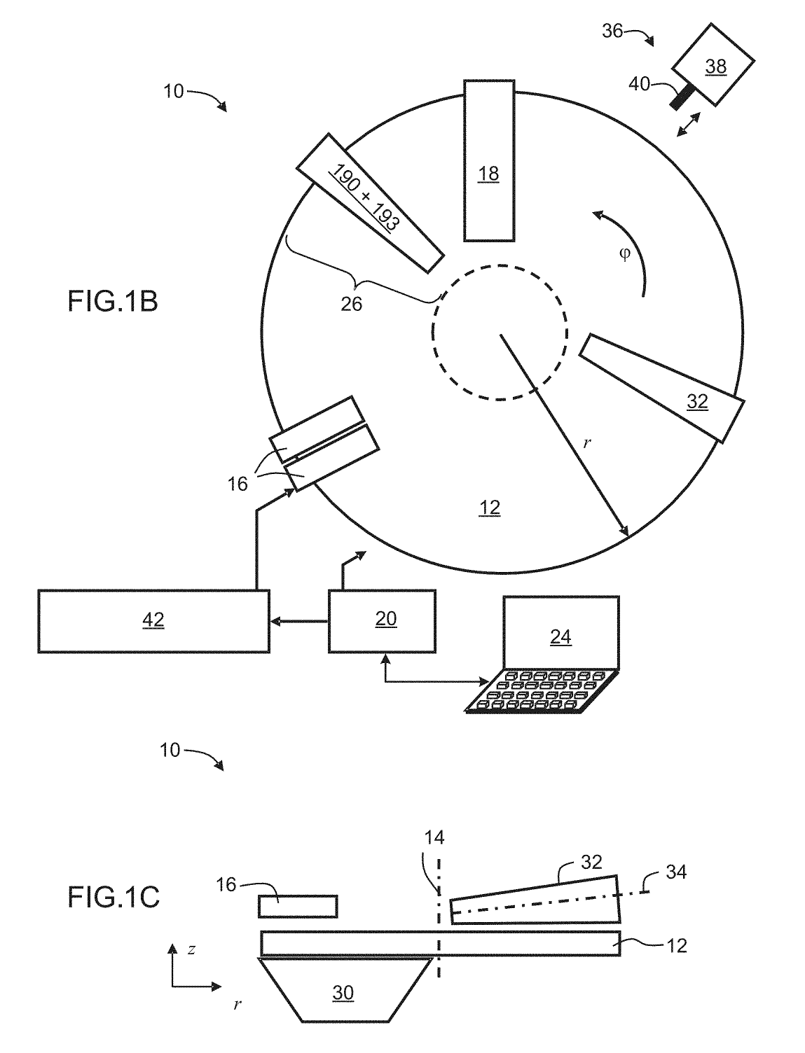

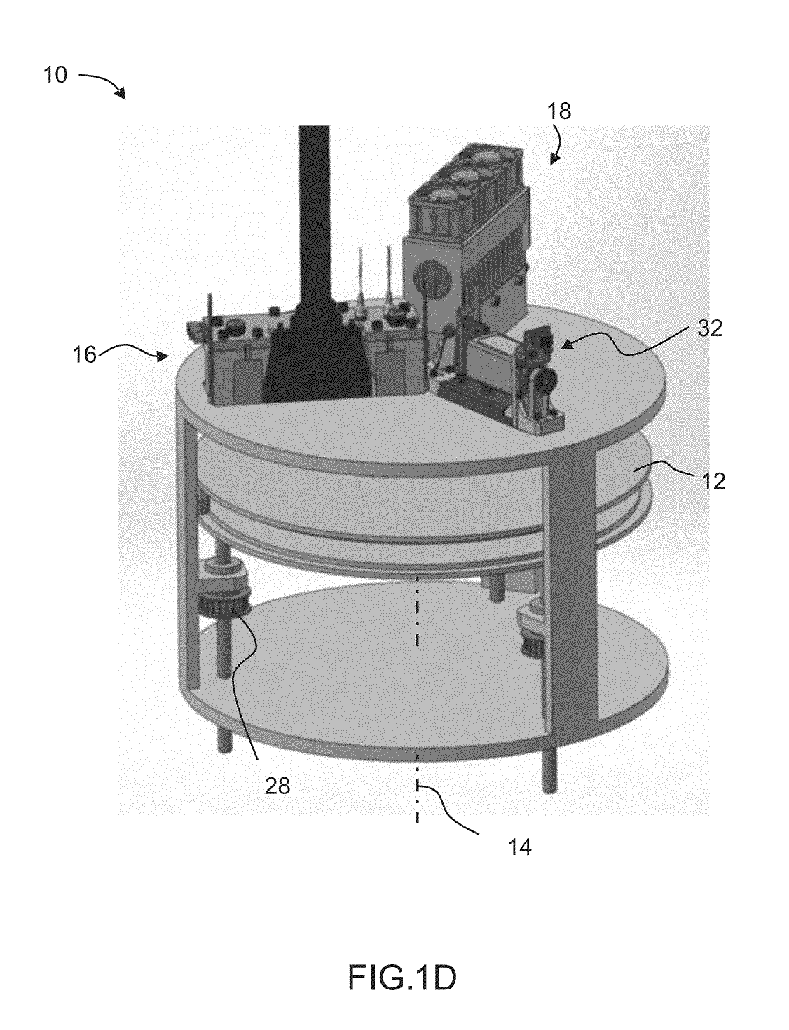

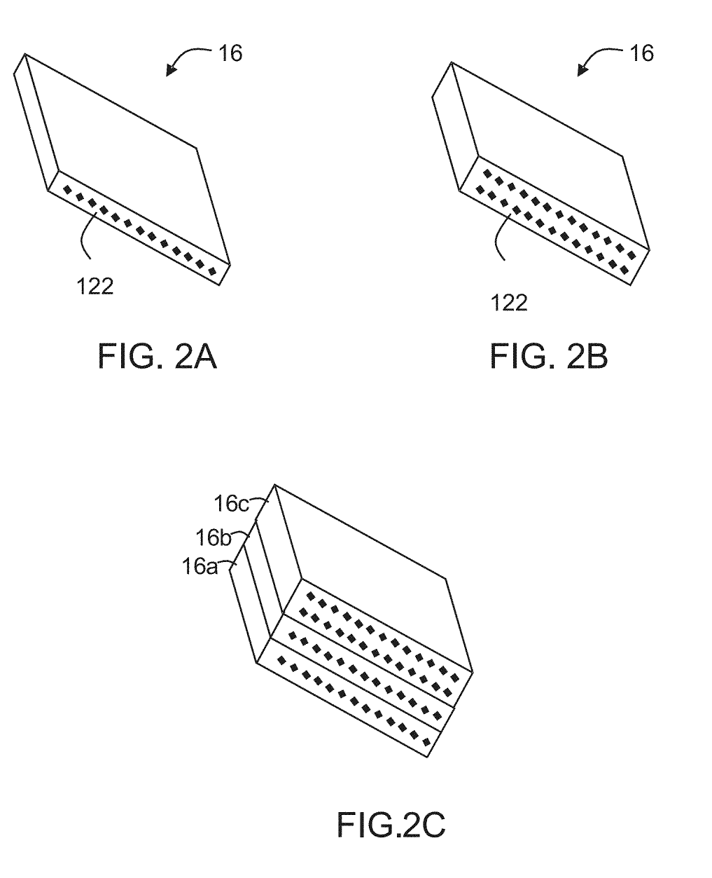

A representative and non-limiting example of a system 110 suitable for AM of an object 112 according to some embodiments of the present invention is illustrated in FIG. 1A. System 110 comprises an AM apparatus 114 having a dispensing unit 16 which comprises a plurality of dispensing heads. Each head preferably comprises an array of one or more nozzles 122, as illustrated in FIGS. 2A-C described below, through which a liquid building material 124 is dispensed. Optionally, the building material is a polymer material, e.g. photopolymer material. Optionally, other material is used.

Preferably, but not obligatorily, apparatus 114 is a 3D droplet deposition, e.g. inkjet printing apparatus, in which case the dispensing heads are printing heads, and the building material is preferably dispensed via inkjet technology. This need not necessarily be the case, since, for some applications, it may not be necessary for the AM apparatus to employ 3D inkjet printing techniques. Representative examples of AM apparatus contemplated according to various exemplary embodiments of the present invention include, without limitation, fused deposition modeling apparatus and fused material deposition apparatus.

Each dispensing head is optionally and preferably fed via a building material reservoir which may optionally include a temperature control unit (e.g., a temperature sensor and/or a heating device), and a material level sensor. To dispense the building material, a voltage signal is applied to the dispensing heads to selectively deposit droplets of material via the dispensing head nozzles, for example, as in piezoelectric inkjet printing technology. The dispensing rate of each head depends on the number of nozzles, the type of nozzles and the applied voltage signal rate (frequency). Such dispensing heads are known to those skilled in the art of solid freeform fabrication.

Preferably, but not obligatorily, the overall number of dispensing nozzles or nozzle arrays is selected such that half of the dispensing nozzles are designated to dispense support material and half of the dispensing nozzles are designated to dispense modeling material, i.e. the number of nozzles jetting modeling materials is the same as the number of nozzles jetting support material. In the representative example of FIG. 1A, four dispensing heads 16a, 16b, 16c and 16d are illustrated. Each of heads 16a, 16b, 16c and 16d has a nozzle array. In this Example, heads 16a and 16b can be designated for modeling material/s and heads 16c and 16d can be designated for support material. Thus, head 16a can dispense a first modeling material, head 16b can dispense a second modeling material and heads 16c and 16d can both dispense support material. In an alternative embodiment, heads 16c and 16d, for example, may be combined in a single head having two nozzle arrays for depositing support material.

Yet it is to be understood that it is not intended to limit the scope of the present invention and that the number of modeling material depositing heads (modeling heads) and the number of support material depositing heads (support heads) may differ. Generally, the number of modeling heads, the number of support heads and the number of nozzles in each respective head or head array are selected such as to provide a predetermined ratio, a, between the maximal dispensing rate of the support material and the maximal dispensing rate of modeling material. The value of the predetermined ratio, a, is preferably selected to ensure that in each formed layer, the height of modeling material in the layer equals the height of support material in the same layer. Typical values for a are from about 0.6 to about 1.5.

As used herein the term “about” refers to ±10%.

For example, for a=1, the overall dispensing rate of support material is generally the same as the overall dispensing rate of the modeling material when all modeling heads and support heads operate.

In a preferred embodiment, there are M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material level sensor of its own, and receives an individually controlled voltage for its operation.

Apparatus 114 can further comprise a hardening device 324 which can include any device configured to emit light, heat or the like that may cause the deposited material to harden. For example, hardening device 324 can include one or more radiation sources, which can be, for example, an ultraviolet or visible or infrared lamp, or other sources of electromagnetic radiation, or electron beam source, depending on the modeling material being used. In some embodiments of the present invention, hardening device 324 serves for curing or solidifying the modeling material.

In some exemplary embodiments, the dispensing head and radiation source are preferably mounted on a frame or block 128 which is preferably operative to reciprocally move over a tray and/or print platen 360, which serves as the working surface. In some embodiments of the present invention the radiation sources are mounted in the block such that they follow in the wake of the dispensing heads to at least partially cure or solidify the materials just dispensed by the dispensing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 132, e.g. a roller 326. Leveling device 326 serves to straighten, level and/or establish a thickness of the newly formed layer prior to the formation of the successive layer thereon. Leveling device 326 preferably comprises a waste collection device 136 for collecting the excess material generated during leveling. Waste collection device 136 may comprise any mechanism that delivers the material to a waste tank or waste cartridge.

According to some embodiments of the present invention, a camera 190 and optionally an illumination source 193 is mounted on block 128. Optionally, illumination source 193 is integrated as part of camera 190 so that camera 190 includes illumination source 193. In some exemplary embodiments, camera 190 includes a two-dimensional image sensor. Optionally, camera 190 is color sensitive. Alternatively, a black and white sensor is used for camera 190. In other embodiments of the present invention, camera 190 is a line camera that is operated to capture an image of one strip at a time as block 128 advances in the X direction. Preferably, the camera is positioned so that the depth of focus is small. Optionally, camera 190 includes a wide angle lens and is positioned to capture an image of a full layer.

According to some embodiments of the present invention, controller 340 controls operation of camera 190 and illumination source 193. Optionally, camera 190 is operated intermittently, e.g. every few layers. Optionally, output from the camera is processed to detect when a portion of the computer object data is not printed. Optionally, in response to missing data extra passes can be initiated. Optionally, output from the camera is processed to detect other errors in printing and in response a pattern for a subsequent layer is adjusted to compensate for the error. In some exemplary embodiments, camera 190 is also used to align dispensing unit 16 prior to printing or after a printing pause.

In use in some exemplary embodiments, the dispensing heads of unit 16 move in a scanning direction, which is referred to herein as the X direction, and selectively dispense building material in a predetermined configuration in the course of their passage over tray 360. The building material typically comprises one or more types of support material and one or more types of modeling material. The passage of the dispensing heads of unit 16 is followed by the curing of the modeling material(s) by radiation source 126. In the reverse passage of the heads, back to their starting point for the layer just deposited, an additional dispensing of building material may be carried out, according to predetermined configuration. In the forward and/or reverse passages of the dispensing heads, the layer thus formed may be straightened by leveling device 326, which preferably follows the path of the dispensing heads in their forward and/or reverse movement. Once the dispensing heads return to their starting point along the X direction, they may move to another position along an indexing direction, referred to herein as the Y direction, and continue to build the same layer by reciprocal movement along the X direction. Alternately, the dispensing heads may move in the Y direction between forward and reverse movements or after more than one forward-reverse movement. The series of scans performed by the dispensing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form 3D object 112 in a layer-wise manner.

In another embodiment, tray 360 may be displaced in the Z direction between forward and reverse passages of the dispensing head of unit 16, within the layer. Such Z displacement is carried out in order to cause contact of the leveling device with the surface in one direction and prevent contact in the other direction.

System 110 optionally and preferably comprises a building material supply system 330 includes the building material containers or cartridges and supplies a plurality of building materials to AM apparatus 114.

A control unit 340 controls apparatus 114 and optionally and preferably also controls supply system 330. Control unit 340 typically includes an electronic circuit configured to perform the controlling operations. Control unit 340 preferably communicates with a processor 154 which transmits digital data pertaining to fabrication instructions based on computer object data, e.g., a CAD configuration represented on a computer readable medium in a form of a Standard Tessellation Language (STL) format or the like. Typically, processor 154 includes a memory unit and/or memory capability for storing computer object data and for storing data pertaining to fabrication instructions based on computer object data. Typically, control unit 340 controls the voltage applied to each dispensing head or nozzle array and the temperature of the building material in the respective printing head.

Once the manufacturing data is loaded to control unit 340 it can operate without user intervention. In some embodiments, control unit 340 receives additional input from the operator, e.g., using data processor 154 or using a user interface 116 communicating with unit 340. User interface 116 can be of any type known in the art, such as, but not limited to, a keyboard, a touch screen and the like. For example, control unit 340 can receive, as additional input, one or more building material types and/or attributes, such as, but not limited to, color, characteristic distortion and/or transition temperature, viscosity, electrical property, magnetic property. Other attributes and groups of attributes are also contemplated.

Another representative and non-limiting example of a rotational system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray and/or print platen 12 and a plurality of inkjet printing heads 16, each having a plurality of separated nozzles. Tray 12 can have a shape of a disk or it can be annular. Non-round shapes are also contemplated, provided they can be rotated about a vertical axis. Typically, system 10 also includes one or more radiation sources 18 and one or more leveling devices 32 and a camera 190 with optional illumination 193.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While the embodiments below are described with a particular emphasis to configuration (i) wherein the tray is a rotary tray that is configured to rotate about vertical axis 14 relative to heads 16, it is to be understood that the present application contemplates also configurations (ii) and (iii). Any one of the embodiments described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersects the vertical axis 14 at a specific point.

Tray 12 serves as a supporting structure for 3D printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. In embodiments in which a particular printing head has two or more linear nozzle arrays, the nozzle arrays are optionally and preferably can be parallel to each other.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a support structure 30 positioned below heads 16 such that tray 12 is between support structure 30 and heads 16. Support structure 30 may serve for preventing or reducing vibrations of tray 12 that may occur while inkjet printing heads 16 operate. In configurations in which printing heads 16 rotate about axis 14, support structure 30 preferably also rotates such that support structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, support structure 30 preferably also moves vertically together with tray 12. In configurations in which the vertical distance is varied by heads 16 along the vertical direction, while maintaining the vertical position of tray 12 fixed, support structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a 3D object in a layer-wise manner.

The operation of inkjet printing heads 16 and optionally and preferably also of one or more other components of system 10, e.g., the motion of tray 12, are controlled by a controller 20. The controller can has an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD). The computer object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

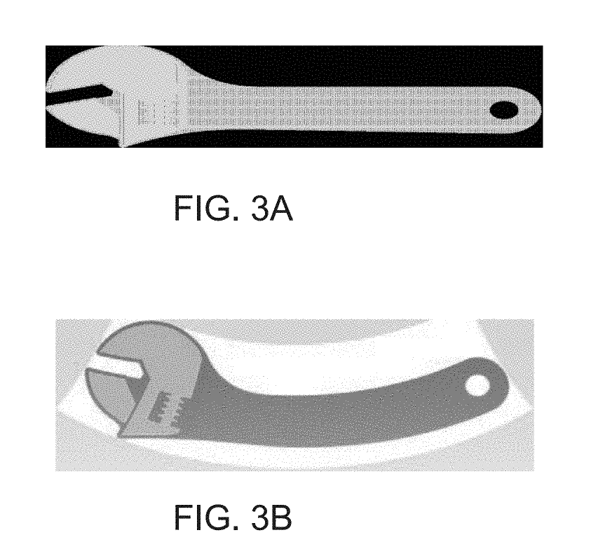

The transformation of coordinates allows 3D printing over a rotating tray. In conventional 3D printing, the printing heads reciprocally move above a stationary tray along straight lines. In such conventional systems, the printing resolution is the same at any point over the tray, provided the dispensing rates of the heads are uniform. Unlike conventional 3D printing, not all the nozzles of the head points cover the same distance over tray 12 during the same time. The transformation of coordinates is optionally and preferably executed so as to ensure equal amounts of excess material at different radial positions. Representative examples of coordinate transformations of computer object data according to some embodiments of the present invention are provided in FIGS. 3A and 3b, showing a slice of an object, where FIG. 3A, illustrate a slice in a Cartesian system of coordinates and FIG. 3B, illustrate the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material in layers, such as to print a 3D object on tray 12.

System 10 optionally and preferably comprises one or more radiation sources 18, which can be, for example, an ultraviolet or visible or infrared lamp, or other sources of electromagnetic radiation, or electron beam source, depending on the modeling material being used. Radiation source can include any type of radiation emitting device, including, without limitation, light emitting diode (LED), digital light processing (DLP) system, resistive lamp and the like. Radiation source 18 serves for curing or solidifying the modeling material. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

According to some embodiments of the present invention, a camera 190 and optionally an illumination source 193 is mounted on a frame above tray 12. Optionally, printing heads 16 are mounted on the same frame. In some exemplary embodiments, camera 190 includes a two-dimensional image sensor. Optionally, camera 190 is color sensitive. Alternatively, a black and white sensor is used for camera 190. In other embodiments of the present invention, camera 190 is a line camera that is operated to capture an image of one circumferential strip at a time as tray 12 is rotated. Preferably, the camera is positioned so that the depth of focus is small. Preferably the camera is positioned so that only images of the present layer are captured. Optionally, camera 190 includes a wide lens to capture a full layer.

According to some embodiments of the present invention, controller 20 controls operation of camera 190 and illumination source 193. Optionally, camera 190 is operated intermittently, e.g. every few layers. Optionally, output from the camera is processed to detect when a portion of the computer object data is not printed. Optionally, in response to missing data extra passes can be initiated. Optionally, output from the camera is processed to detect other errors and in response, a pattern of subsequent layers is altered to compensate for the error. In some exemplary embodiments, camera 190 is also used to align dispensing unit 16 prior to printing or after a printing pause.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different materials from different dispensing heads. These embodiments provide, inter alia, the ability to select materials from a given number of materials and define desired combinations of the selected materials and their properties. According to the present embodiments, the spatial locations of the deposition of each material with the layer is defined, either to effect occupation of different 3D spatial locations by different materials, or to effect occupation of substantially the same 3D location or adjacent 3D locations by two or more different materials so as to allow post deposition spatial combination of the materials within the layer, thereby to form a composite material at the respective location or locations.

Any post deposition combination or mix of modeling materials is contemplated. For example, once a certain material is dispensed it may preserve its original properties. However, when it is dispensed simultaneously with another modeling material or other dispensed materials which are dispensed at the same or nearby locations, a composite material having a different property or properties to the dispensed materials is formed.

The present embodiments thus enable the deposition of a broad range of material combinations, and the fabrication of an object which may consist of multiple different combinations of materials, in different parts of the object, according to the properties desired to characterize each part of the object.

Further details on the principles and operations of an AM system suitable for the present embodiments are found in U.S. Pat. No. 9,031,680, the contents of which are hereby incorporated by reference.

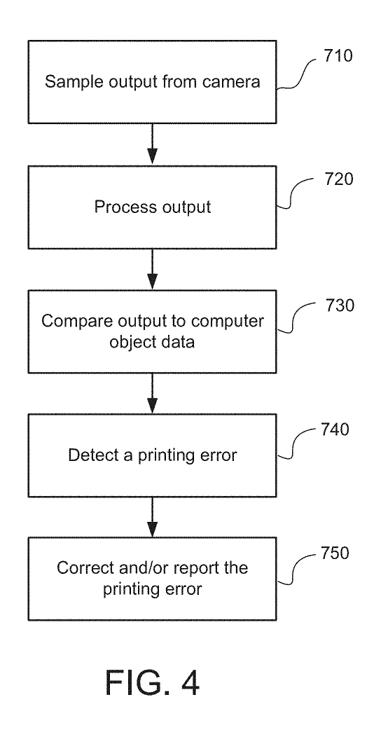

FIG. 4 shows a simplified flow chart of an exemplary method for monitoring manufacturing of an object with an AM system in accordance with some embodiments of the present invention. According to some embodiments of the present invention, output from camera 190 is sampled (block 710). Typically controller 340 or controller 20 controls operation of camera 190. Typically, controller 340 or controller 20 also controls operation of lighting unit 193. According to some embodiments of the present invention, output sampled from the camera is processed (block 720). In some exemplary embodiments, the processing provides for identifying errors in printing. According to some embodiments of the present invention, printing errors are identified by comparing sampled output with computer object data (block 730). Optionally, processing and/or comparing reveals that material is missing. Once a printing error is detected (block 740), the AM system may correct the error without operator intervention and/or may report the error (block 750). Optionally, correction can be by extra passes to fill missing material. Optionally, processing and/or comparing reveals an overflow of material and correction can be by altering a pattern of a subsequent layer.

Optionally, reporting is by displaying a message on an electronic display of processor 154. Optionally, an audio signal is sounded. In some exemplary embodiments, printing is paused in response to detecting a printing error. Optionally, the camera is also used to align dispensing unit 16 after a pause in printing. Optionally, the camera is also used to align dispensing unit 16 at the onset of printing.

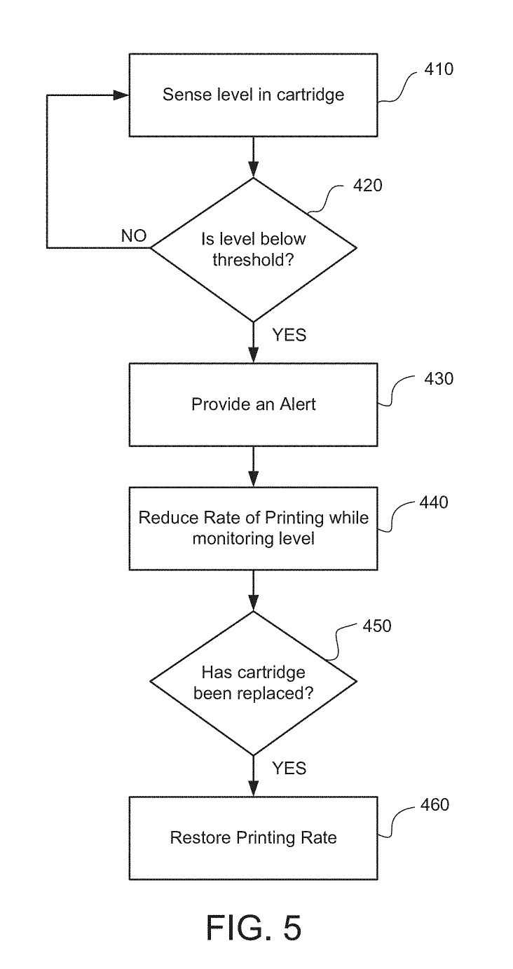

FIG. 5 shows a simplified flow chart of an exemplary method for replacing printing cartridges while printing in accordance with some embodiments of the present invention. According to some embodiments of the present invention, an AM manufacturing system includes one or more sensors, e.g. one sensor per cartridge of a supply apparatus for sensing a level of consumable material (block 410). Optionally, a load cell, drop counter and/or a timer is used to detect or estimate when the cartridge needs replacing. Typically, the sensor detects or estimates when the level is below a threshold value indicating that the cartridge should be replaced (block 420). According to some embodiments of the present invention, once the threshold is crossed, the AM system alerts an operator (block 430) with an audio signal, and/or a visual signal. Optionally, a warning is displayed on an electronic display associated with a processor of the system. Typically, the warning identifies the cartridge that needs replacing. Optionally, more than one cartridge needs replacing at the same time. According to some embodiments of the present invention, a control unit of the system concurrently slows down the rate of printing (block 440). Alternatively, the printing rate is reduced only after the cartridge is removed. Optionally, the sensor detects removal of the cartridge. Alternatively, removal of the cartridge is detected with a dedicated sensor. Optionally, the rate of printing can be reduced by 30%-80%. Optionally, the rate of printing is reduced as a function of a concurrent level in cartridge or estimated level of material in dispensing unit, e.g. dispensing unit 16 and connecting tubes.

According to some embodiments of the present invention, the AM system detects replacement of the cartridge based on the level sensor or other sensor (block 450) and restores the rate of printing once a new cartridge is installed (block 460). Optionally, the rate of printing is restored only after all the empty cartridges are replaced.

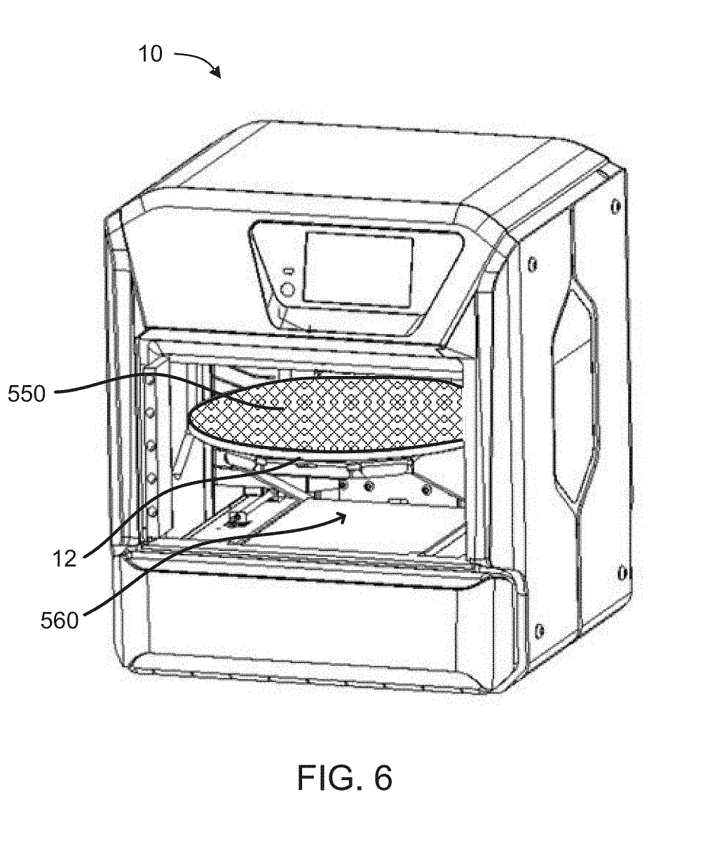

FIG. 6 illustrates an exemplary 3D printing system including a tray with removable lining in accordance with some embodiments of the present invention. Typically, tray 12 is an aluminum plate which is configured to rotate during printing. According to some embodiments of the present invention, a tray 12 (or a tray 360) is lined with a removable substrate 550. Typically, substrate 550 is hydrophobic. Substrate 550 can be a metal or plastic lining. According to some embodiments of the present invention, substrate 550 is removably attached to tray 12 so that substrate 550 is stationary with respect to tray 12 during AM, while tray 12 is rotating and can be easily removed together with the manufactured object at the end of the printing process. In some exemplary embodiments, tray 12 is magnetized and substrate 550 is secured in place by magnetic force. Alternatively, substrate 550 is held in place using vacuum force, adhesive material, or mechanically with clasps. Optionally, tray 12 includes a plurality of holes and/or slits through which a vacuum source is connected. Optionally, a vacuum force may be created by the rotation of the tray.

According to some embodiments of the present invention, substrate 550 is configured to be cleaned after separating the manufactured object from substrate 550 and repositioned on tray 12. In some known systems, cleaning tray 12 is required to be cleaned after printing. This task may be cumbersome since some areas in a printing chamber 560 of the AM system are not easily accessible. In addition, there is a risk of contaminating other areas of printing chamber 560 during cleaning. According to some embodiments of the present invention, the need to clean tray 12 is avoided by using substrate 550. Instead, substrate 550 can be cleaned when it is removed from changer 560 or can be replaced with another substrate.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1-25. (canceled)

26. A method for Additive Manufacturing comprising:
detecting that a cartridge for supplying building material is emptying;
initiating an alert configured to alert an operator to replace the cartridge; and
reducing a rate of printing over a period that an operator is replacing the cartridge.

27. The method of claim 26 comprising:
detecting replacement of the cartridge; and
restoring the rate of printing based on the detecting replacement.

28. The method of claim 26, wherein the detecting that a cartridge is emptying is with a drop counter.

29. The method of claim 26, wherein the rate of printing is reduced by 30 to 80 percent.

30. The method of claim 26, comprising:
detecting that two cartridges are emptying; and
restoring the rate of printing based on detecting replacement of the two cartridges.

31. An Additive Manufacturing (AM) system comprising:
a dispensing unit configured to dispense building material in a layer-wise manner to manufacture an object;
a supply system including one or more cartridges, the cartridges configured to supply building material to the dispensing unit;
a sensor configured to detect that a cartridge is emptying; and
a controller configured to:
initiate an alert to alert an operator to replace the cartridge; and
reduce a rate of printing over a period that an operator is replacing the cartridge.

32. The AM system of claim 31, wherein the sensor is configured to detect that the cartridge has been replaced.

33. The AM system of claim 31 wherein the controller is configured to restore the rate of printing when the cartridge is replaced.

34. The AM system of claim 31, wherein the sensor is any one or more of a load cell a drop counter and a timer.

35-38. (canceled)

39. The method of claim 26, wherein initiating an alert comprises initiating any one or more of an audio signal, a visual signal and a warning displayed on an electronic display associated with a processor of the system.

40. The AM system of claim 31, wherein the AM system comprises one sensor per cartridge.

41. The AM system of claim 31, further comprising a user interface that alerts the user when the cartridges are close to emptying.

42. The AM system of claim 31, further comprising an electronic warning display associated with a processor of the system.
